(19) United States
(12) Patent Application Publication
(10) Pub. No.: US 2011/0001819 A1
(43) Pub. Date: Jan. 6, 2011

(54) Image Processing Apparatus

(75) Inventor: Keisuke ASARI, Katano-shi (JP)

Correspondence Address: NOVAK DRUCE + QUIGG LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/823,409

(22) Filed: Jun. 25, 2010

(30) Foreign Application Priority Data
Jul. 2, 2009 (JP) 2009-157473

(51) Int. Cl. H04N 7/18

(52) U.S. Cl. 348/113; 348/E07.085

(57) ABSTRACT

An image processing apparatus includes a plurality of cameras which are arranged at respectively different positions of a moving body moving on a reference surface, and output an object scene image representing a surrounding area of the moving body. A first creator creates a bird's-eye view image relative to the reference surface, based on the object scene images outputted from the plurality of cameras. A first displayer displays the bird's-eye view image created by the first creator, on a monitor screen. A detector detects a location of the moving body in parallel with a creating process of the first creator. A second creator creates navigation information based on a detection result of the detector and map information. A second displayer displays the navigation information created by the second creator on the monitor screen in association with a displaying process of the first displayer.

### CROSS REFERENCE OF RELATED APPLICATION

The disclosure of Japanese Patent Application No. 2009-157473, which was filed on Jul. 2, 2009, is incorporated herein by reference.

### BACKGROUND OF THE INVENTION

1. Field of the Invention

The present invention relates to an image processing apparatus. More particularly, the present invention relates to an image processing apparatus which displays on a screen, together with navigation information, an image representing an object scene captured by cameras arranged in a moving body.

2. Description of the Related Art

According to one example of this type of apparatus, a scenery in an advancing direction of an automobile is captured by a camera attached at the nose of the automobile. An image combiner combines a navigation information element onto an actually photographed image captured by the camera, and displays the combined image on a display machine. This enables a driver to comprehend more sensuously a current position or an advancing path of the automobile.

However, the actually photographed image combined with the navigation information element merely represents the scenery in the advancing direction of the automobile. Thus, the above-described apparatus is limited in its steering assisting performance.

### SUMMARY OF THE INVENTION

An image processing apparatus according to the present invention comprises: a plurality of cameras which are arranged at respectively different positions of a moving body moving on a reference surface and which output object scene images representing a surrounding area of the moving body; a first creator which creates a bird's-eye view image relative to the reference surface, based on the object scene images outputted from the plurality of cameras; a first displayer which displays the bird's-eye view image created by the first creator, on a monitor screen; a detector which detects a location of the moving body, in parallel with a creating process of the first creator; a second creator which creates navigation information based on a detection result of the detector and map information; and a second displayer which displays on the monitor screen the navigation information created by the second creator, in association with a displaying process of the first displayer.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is a perspective view showing one example of a vehicle on which an embodiment in FIG. 2 is mounted;

FIG. 4 is an illustrative view showing a viewing field captured by a plurality of cameras attached to a vehicle;

FIG. 5 is an illustrative view showing one portion of behavior of creating a bird's-eye view image based on output of the cameras;

FIG. 6 is an illustrative view showing one example of a drive assisting image displayed by a display device;

FIG. 7(A) is an illustrative view showing one example of a drive assisting image displayed corresponding to a parallel display mode;

FIG. 7(B) is an illustrative view showing one example of a drive assisting image displayed corresponding to a multiple display mode;

FIG. 8 is an illustrative view showing one example of a warning displayed when an obstacle is detected;

FIG. 9 is a flowchart showing one portion of an operation of a CPU applied to the embodiment in FIG. 2;

FIG. 10 is a flowchart showing another portion of the operation of the CPU applied to the embodiment in FIG. 2;

FIG. 11 is a flowchart showing still another portion of the operation of the CPU applied to the embodiment in FIG. 2;

FIG. 12 is a flowchart showing yet still another portion of the operation of the CPU applied to the embodiment in FIG. 2.

FIG. 13(A) is an illustrative view showing one example of a drive assisting image displayed in another embodiment;

FIG. 13(B) is an illustrative view showing another example of the drive assisting image displayed in the other embodiment;

FIG. 14 is a flowchart showing one portion of an operation of a CPU applied to the other embodiment; and

FIG. 15 is a flowchart showing another portion of the operation of the CPU applied to the other embodiment.

### DETAILED DESCRIPTION OF THE PREFERRED EMBODIMENTS

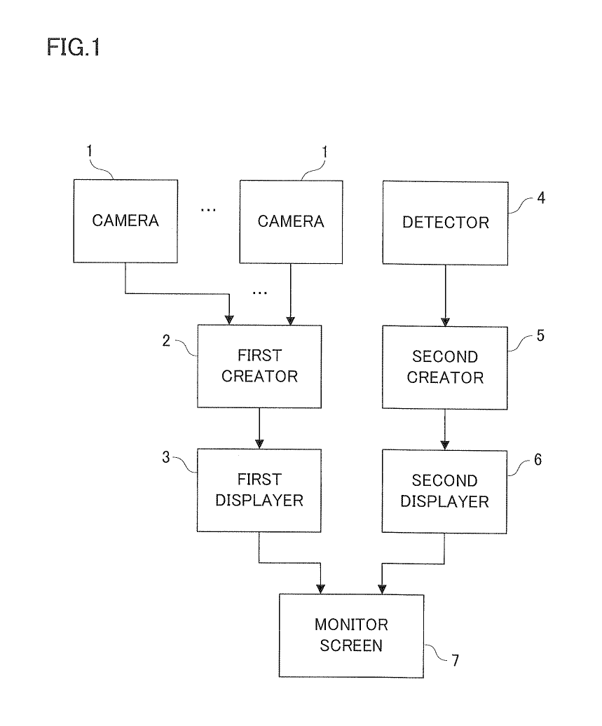

With reference to FIG. 1, an image processing apparatus of one embodiment of the present invention is basically configured as follows: A plurality of cameras 1, 1, . . . are arranged at respectively different positions of a moving body moving on a reference surface, and output object scene images representing a surrounding area of the moving body. A first creator 2 creates a bird's-eye view image relative to the reference surface, based on the object scene images outputted from the plurality of cameras 1, 1, . . . . A first displayer 3 displays the bird's-eye view image created by the first creator 2, on a monitor screen 7. A detector 4 detects a location of the moving body in parallel with a creating process of the first creator 2. A second creator 5 creates navigation information based on a detection result of the detector 4 and map information. A second displayer 6 displays the navigation information created by the second creator 5 on the monitor screen 7 in association with a displaying process of the first displayer 3.

The bird's-eye view image is created based on output from the plurality of cameras 1, 1, . . . arranged at the respectively different positions of the moving body, and reproduces the surrounding area of the moving body. The navigation information created based on the location of the moving body and the map information is displayed on the monitor screen 7 together with such a bird's-eye view image. This enables confirmation of both of the safety of the surrounding area of the moving body and the navigation information on the same screen, thereby improving a steering assisting performance.

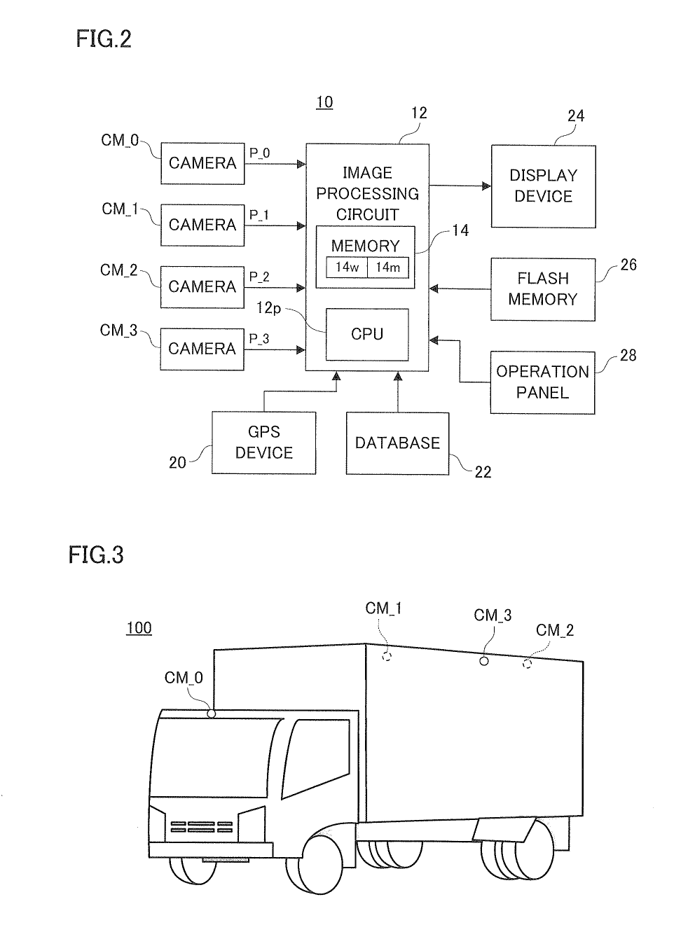

A steering assisting apparatus 10 of this embodiment shown in FIG. 2 includes four cameras CM_0 to CM_3. The cameras CM_0 to CM_3 output object scene images P_0 to P_3 at every 1/30th of a second, respectively. The outputted object scene images P_0 to P_3 are applied to an image processing circuit 12.

With reference to FIG. 3, the camera CM_0 is installed at a front upper side portion of a vehicle 100 so that an optical axis of the camera CM_0 is oriented to extend in a forward diagonally downward direction of the vehicle 100. The camera CM_1 is installed at a right upper side portion of the vehicle 100 so that an optical axis of the camera CM_1 is oriented to extend in a rightward diagonally downward direction of the vehicle 100. The camera CM_2 is installed at a rear upper side portion of the vehicle 100 so that an optical axis of the camera CM_2 is oriented to extend in a backward diagonally downward direction of the vehicle 100. The camera CM_3 is installed at a left upper side portion of the vehicle 100 so that an optical axis of the camera CM_3 is oriented to extend in a leftward diagonally downward direction of the vehicle 100. The object scene in the surrounding area of the vehicle 100 is captured by such cameras CM_0 to CM_3 from a direction diagonally crossing a road surface.

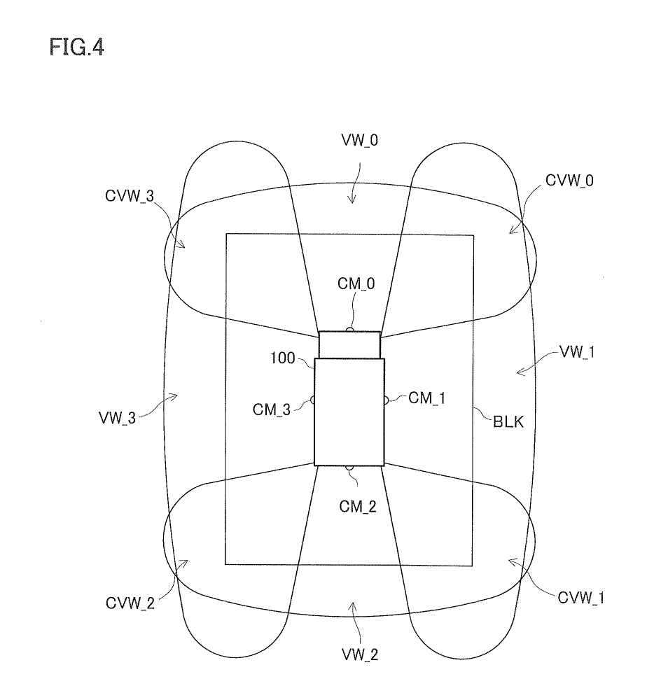

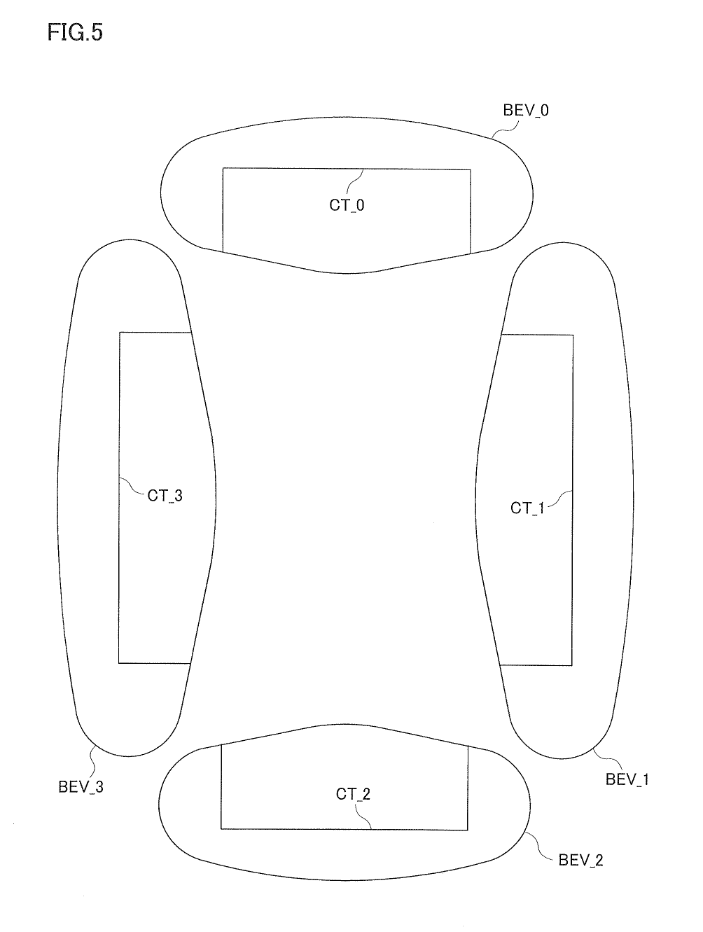

As shown in FIG. 4, the camera CM_0 has a viewing field VW_0 capturing a front direction of the vehicle 100, the camera CM_1 has a viewing field VW_1 capturing a right direction of the vehicle 100, the camera CM_2 has a viewing field VW_2 capturing a rear direction of the vehicle 100, and the camera CM_3 has a viewing field VW_3 capturing a left direction of the vehicle 100. It is noted that the viewing fields VW_0 and VW_1 have a common viewing field CVW_0, the viewing fields VW_1 and VW_2 have a common viewing field CVW_1, the viewing fields VW_2 and VW_3 have a common viewing field CVW_2, and the viewing fields VW_3 and VW_0 have a common viewing field CVW_3.

Returning to FIG. 2, a CPU 12p arranged in the image processing circuit 12 produces a bird's-eye view image BEV_0 based on the object scene image P_0 outputted from the camera CM_0, and produces a bird's-eye view image BEV_1 based on the object scene image P_1 outputted from the camera CM_1. Moreover, the CPU 12p produces a bird's-eye view image BEV_2 based on the object scene image P_2 outputted from the camera C_2, and produces a bird's-eye view image BEV_3 based on the object scene image P_3 outputted from the camera C_3.

As can be seen from FIG. 5, the bird's-eye view image BEV_0 is equivalent to an image captured by a virtual camera looking perpendicularly down onto the viewing field VW_0, and the bird's-eye view image BEV_1 is equivalent to an image captured by a virtual camera looking perpendicularly down onto the viewing field VW_1. Moreover, the bird's-eye view image BEV_2 is equivalent to an image captured by a virtual camera looking perpendicularly down onto the viewing field VW_2, and the bird's-eye view image BEV_3 is equivalent to an image captured by a virtual camera looking perpendicularly down onto the viewing field VW_3. The produced bird's-eye view images BEV_0 to BEV_3 are held in a work area 14w of a memory 14.

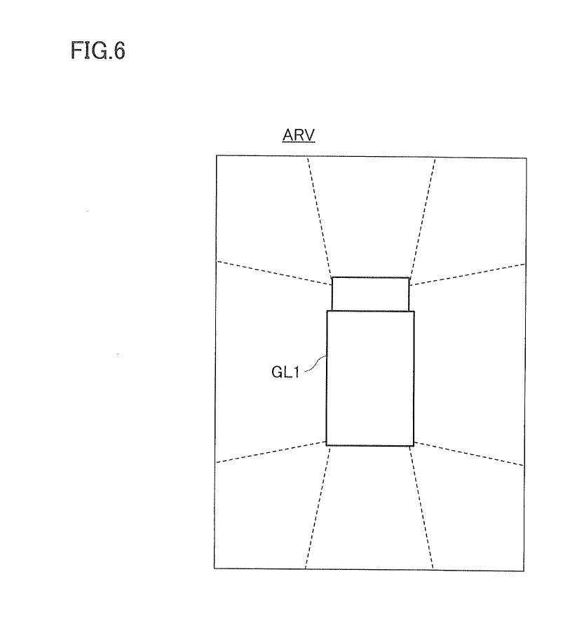

Subsequently, the CPU 12p defines cut-out lines CT_0 to CT_3 corresponding to a reproduction block BLK shown in FIG. 4, on the bird's-eye view images BEV_0 to BEV_3, creates a complete-surround bird's-eye view image by combining parts of images present inside the defined cut-out lines CT_0 to CT_3, and pastes a vehicle image GL1 resembling an upper portion of the vehicle 100 onto a center of the complete-surround bird's-eye view image. Thus, a drive assisting image ARV shown in FIG. 6 is completed on the work area 14w.

In parallel with a process for creating such a drive assisting image ARV, the CPU 12p detects a current position or location of the vehicle 100 based on output of a GPS device 20, and further determines whether a display mode at a current time point is either a parallel display mode or a multiple display mode. It is noted that the display mode can be switched between the parallel display mode and the multiple display mode in response to a mode switching operation on an operation panel 28.

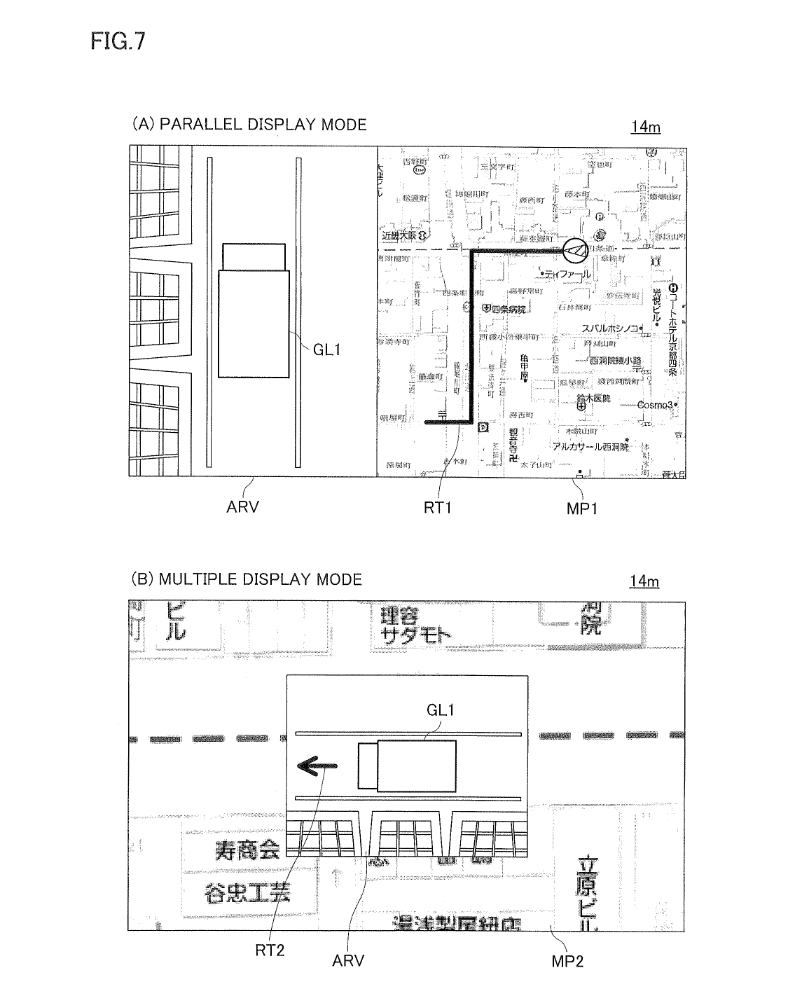

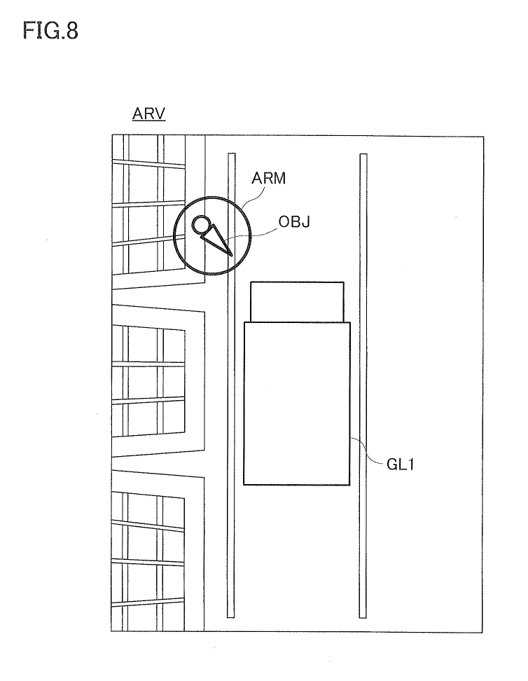

If the display mode at a current time point is the parallel display mode, then the CPU 12p creates a wide-area map image MP1 representing the current position of the vehicle 100 and its surrounding area, based on map data saved on a database 22. The created wide-area map image MP1 is developed on a right side of a display area 14m formed on the memory 14, as shown in FIG. 7(A). Subsequently, the CPU 12p adjusts a magnification of the drive assisting image ARV held in the work area 14w so as to be adapted to the parallel display mode, and develops the drive assisting image ARV having the adjusted magnification, on a left side of the display area 14m, as shown in FIG. 7(A).

A display device 24 set onto a driver's seat of the vehicle 100 repeatedly reads out the wide-area map image MP1 and the drive assisting image ARV developed in the display area 14m, and displays the read-out wide-area map image MP1 and drive assisting image ARV, on the same screen, as shown in FIG. 7(A).

On the other hand, if the display mode at a current time point is the multiple display mode, then the CPU 12p creates a narrow-area map image MP2 representing the current position of the vehicle 100 and its surrounding area, based on the map data saved on the database 22. The created narrow-area map image MP2 is developed on whole of the display area 14m, as shown in FIG. 7(B).

Subsequently, the CPU 12p adjusts the magnification of the drive assisting image ARV so as to be adapted to the multiple display mode, detects the orientation of the vehicle 100 at a current time point based on the output of the GPS device 20, and detects road surface paint appearing in the drive assisting image ARV by pattern recognition. An overlay position of the drive assisting image ARV is determined based on the orientation of the vehicle 100 and the road surface paint, and the drive assisting image ARV having the adjusted magnification is overlaid onto the determined overlay position, as shown in FIG. 7(B).

More particularly, the magnification of the drive assisting image ARV is adjusted so that a width of the road surface on the drive assisting image ARV matches a width of the road surface on the narrow-area map image. Moreover, the overlay position of the drive assisting image ARV is adjusted so that the road surface paint on the drive assisting image ARV fits along the road surface paint on the narrow-area map image. It is noted that the orientation of the vehicle 100 is referred to in order to avoid a situation where a vehicle image G1 is overlaid onto a road surface on an opposite vehicle lane on the narrow-area map image.

The display device 24 repeatedly reads out the narrow-area map image MP2 and the drive assisting image ARV which are developed in the display area 14m, and displays the read-out narrow-area map image MP2 and drive assisting image ARV, on the screen.

If an operation for setting a target site is performed on the operation panel 28 shown in FIG. 2, then the CPU 12p detects the current position based on the output of the GPS device 20, and sets a route to the target site based on the detected current position and the map data saved in the database 22.

If the display mode at a current time point is the parallel display mode, then the CPU 12p creates route information RT1 indicating the route to the target site in a wide area, and overlays the created route information RT1 onto the wide-area map image MP1 developed in the display area 14m. On the other hand, if the display mode at a current time point is the multiple display mode, then the CPU 12p creates route information RT2 indicating the route to the target site in a narrow area, and overlays the created route information RT2 onto the drive assisting image ARV developed in the display area 14m. The route information RT1 is overlaid as shown in FIG. 7(A), and the route information RT2 is overlaid as shown in FIG. 7(B). Both the overlaid route information RT1 and RT2 are displayed on the screen of the display device 24.

It is noted that in this embodiment, the wide-area map image MP1, the narrow-area map image MP2, the route information RT1, and the route information RT2 are collectively called “navigation information”.

Furthermore, the CPU 12p refers to the drive assisting image ARV in order to repeatedly search the obstacle from the surrounding area of the vehicle 100. If an obstacle OBJ is discovered, then the CPU 12p overlays warning information ARM onto the drive assisting image ARV developed in the display area 14m. The warning information. ARM is overlaid corresponding to a position of the obstacle OBJ, as shown in FIG. 8. Also the overlaid warning information ARM is displayed on the screen of the display device 24.

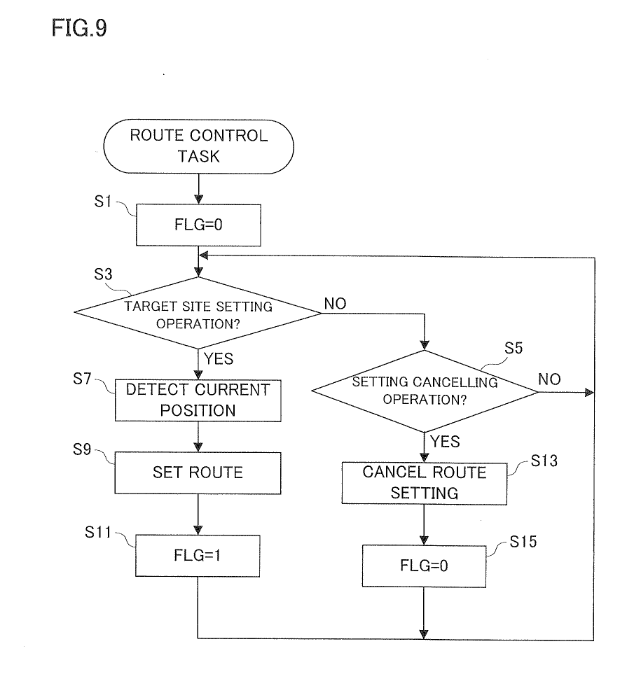

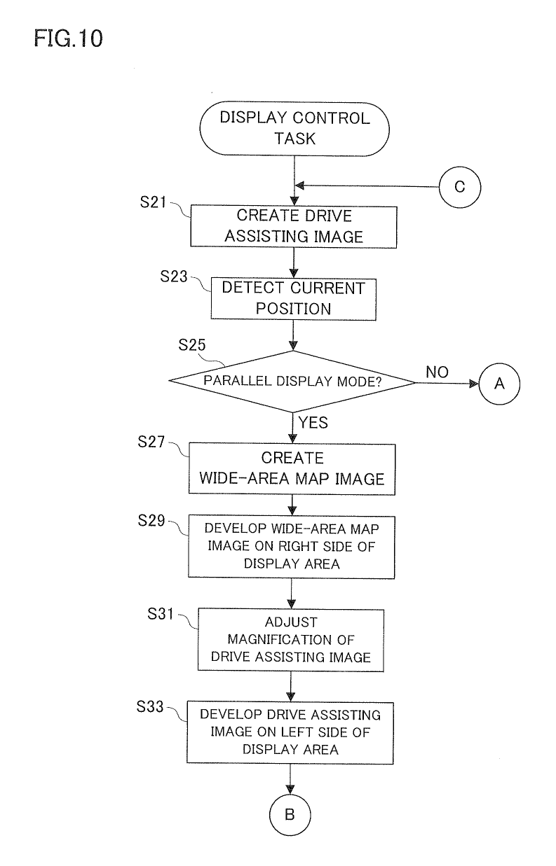

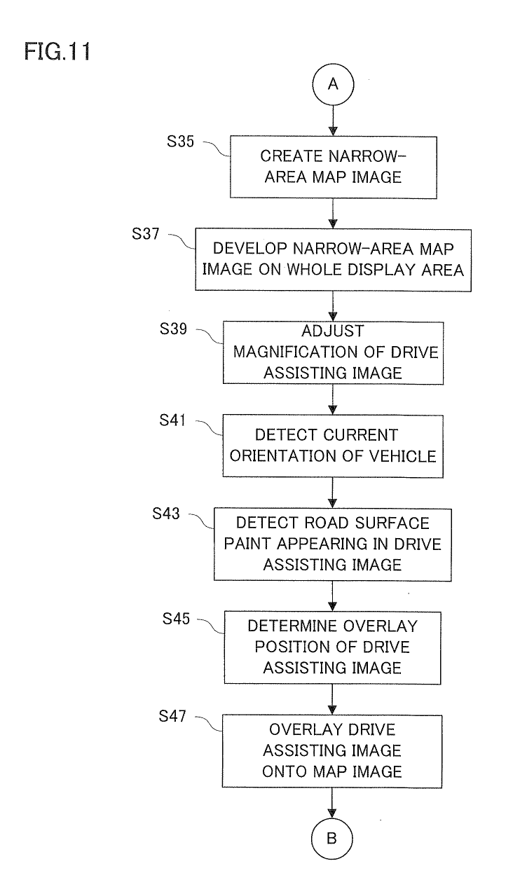

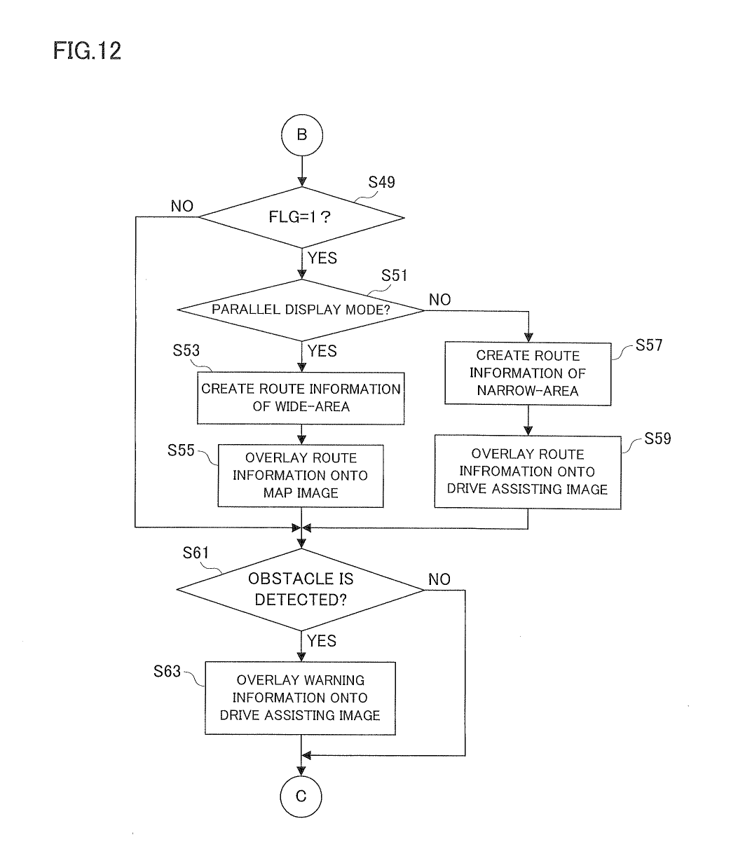

The CPU 12p executes a plurality of tasks including a route control task shown in FIG. 9 and a display control task shown in FIG. 10 to FIG. 12, in a parallel manner. It is noted that control programs corresponding to these tasks are stored in the flash memory 26.

With reference to FIG. 9, in a step S1, a flag FLG is set to “0”. The flag FLG is a flag for identifying whether the target site is set/unset. FLG=0 indicates “unset” while FLG=1 indicates “set”. In a step S3, it is determined whether or not the operation for setting the target site is performed on the operation panel 28, and in a step S5, it is determined whether or not a setting canceling operation is performed on the operation panel 28.

When YES is determined in the step S3, the process advances to a step S7 so as to detect the current position based on the output of the GPS device 20. In a step S9, based on the detected current position and the map data saved in the database 22, the route to the target site is set. Upon completion of the process in the step S9, the flag FLG is set to “1” in a step S11, and thereafter, the process returns to the step S3.

When YES is determined in the step S5, the process advances to a step S13 so as to cancel the setting of the route to the target site. Upon completion of the process in the step S13, the flag FLG is set to “0” in a step S15, and thereafter, the process returns to the step S3.

With reference to FIG. 10, in a step S21, the drive assisting image ARV is created based on the object scene images P_0 to P_3 outputted from the cameras CM_0 to CM_3. In a step S23, the current position of the vehicle 100 is detected based on the output of the GPS device 20. In a step S25, it is determined whether or not the display mode at a current time point is either the parallel display mode or the multiple display mode. If a determined result is the parallel display mode, then the process advances to a step S27 while if the determined result is the multiple display mode, then the process advances to a step S35.

In the step S27, the wide-area map image MP1 representing the current position of the vehicle 100 and its surrounding area is created based on the map data saved in the database 22. In a step S29, the created wide-area map image MP1 is developed on the right side of the display area 14m. In a step S31, the magnification of the drive assisting image ARV created in the step S21 is adjusted so as to be adapted to the parallel display mode. In a step S33, the drive assisting image ARV having the adjusted magnification is developed on the left side of the display area 14m. Upon completion of the process in the step S33, the process advances to a step S49.

In the step S35, the narrow-area map image MP2 representing the current position of the vehicle 100 and its surrounding area is created based on the map data saved in the database 22. In a step S37, the created narrow-area map image MP2 is developed on whole of the display area 14m. In a step S39, the magnification of the drive assisting image ARV created in the step S21 is adjusted so as to be adapted to the multiple display mode.

In a step S41, the orientation of the vehicle 100 at a current time point is detected based on the output of the GPS device 20, and in a step S43, the road surface paint appearing in the drive assisting image ARV is detected by the pattern recognition. In a step S45, based on the orientation of the vehicle 100 detected in the step S41 and the road surface paint detected in the step S43, the overlay position of the drive assisting image ARV is determined. In a step S47, the drive assisting image ARV having the magnification adjusted in the step S39 is overlaid onto the position determined in the step S45. Upon completion of the process in the step S47, the process advances to the step S49.

In the step S49, it is determined whether or not the flag FLG indicates “1”. When a determined result is NO, the process directly advances to the step S61, and when the determined result is YES, the process advances to the step S61 after undergoing steps S51 to S59.

In the step S51, it is determined whether or not the display mode at a current time point is either the parallel display mode or the multiple display mode. If the display mode at a current time point is the parallel display mode, then the process advances to the step S53 in order to create the route information RT1 indicating the route to the target site in a wide area. In the step S55, the created route information RT1 is overlaid onto the wide-area map image MP1 developed in the step S29. If the display mode at a current time point is the multiple display mode, then the process advances to the step S57 in order to create the route information RT2 indicating the route to the target site in a narrow area. In the step S59, the created route information RT2 is overlaid onto the drive assisting image ARV developed in the step S47.

In a step S61, it is determined whether or not there is the obstacle OBJ in the surrounding area of the vehicle 100. When a determined result is NO, the process directly returns to the step S21 while when the determined result is YES, the process returns to the step S21 after overlaying the warning information ARM onto the drive assisting image ARV in a step S63. The warning information ARM is overlaid onto the drive assisting image ARV, corresponding to the position of the obstacle OBJ.

As can be seen from the above-described explanation, the cameras CM_0 to CM_3 are arranged at the respectively different positions of the vehicle 100 moving on the road surface, and output the object scene images P_0 to P_3 representing the surrounding area of the vehicle 100. The CPU 12p creates the drive assisting image ARV based on the outputted object scene images P_0 to P_3 (S21), and displays the created drive assisting image ARV on the screen of the display device 24 (S31 to S33, and S39 to S47). Moreover, the CPU 12p detects the location of the vehicle 100, in parallel with the process for creating the drive assisting image ARV (S23), creates the navigation information (the map image and the route information) based on the detected location and the map data in the database 22 (S27, S35, S53, S57), and displays the created navigation information on the screen of the display device 24 (S29, S37, S55, S59).

The drive assisting image ARV is created based on the output from the cameras CM_0 to CM_3 arranged at the respectively different positions of the vehicle 100, and reproduces the surrounding area of the vehicle 100. The navigation information created based on the location of the vehicle 100 and the map data is displayed on the display device 24 together with such a drive assisting image ARV. This enables confirmation of both of the safety of the surrounding area of the vehicle 100 and the navigation information on the same screen, thereby improving a steering assisting performance.

It is noted that in this embodiment, the route information RT1 is overlaid onto the wide-area map image MP1, the drive assisting image ARV is overlaid onto the narrow-area map image MP2, the route information RT2 is overlaid onto the drive assisting image ARV, and the warning information ARM is overlaid onto the drive assisting image ARV. Herein, a transmissivity of the overlaid image is not limited to 0%, and may be appropriately adjusted within a range of 1 to 99%.

Moreover, in this embodiment, the vehicle traveling on the road surface is assumed as the moving body. It is, however, also possible to adapt the present invention to a ship sailing on a sea surface.

Moreover, in this embodiment, the parallel display mode and the multiple display mode alternately selected by the mode switching operation are prepared, and the wide-area map image MP1 and the drive assisting image ARV are displayed in parallel in the parallel display mode while the narrow-area map image MP2 and the drive assisting image ARV are multiple-displayed in the multiple display mode.

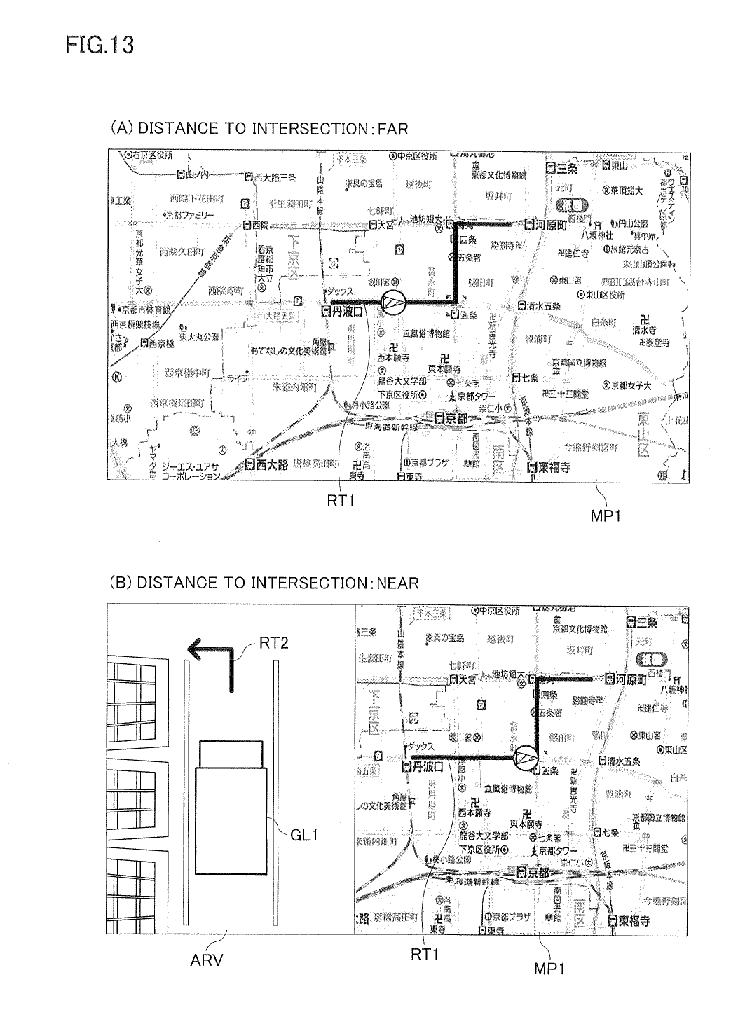

However, the following may be optionally arranged: when the vehicle 100 remains away from an intersection at which to turn left or right, the wide-area map image MP1 is displayed on whole of the monitor screen and the wide-area route information RT1 is overlaid on the wide-area map image MP1 (see FIG. 13(A)) while when the vehicle 100 approaches the intersection at which to turn left or right, the wide-area map image MP1 and the drive assisting image ARV are displayed in parallel on the monitor screen and the wide-area route information RT1 and the narrow-area route information RT2 are overlaid on the wide-area map image MP1 and the drive assisting image ARV, respectively (see FIG. 13(B)).

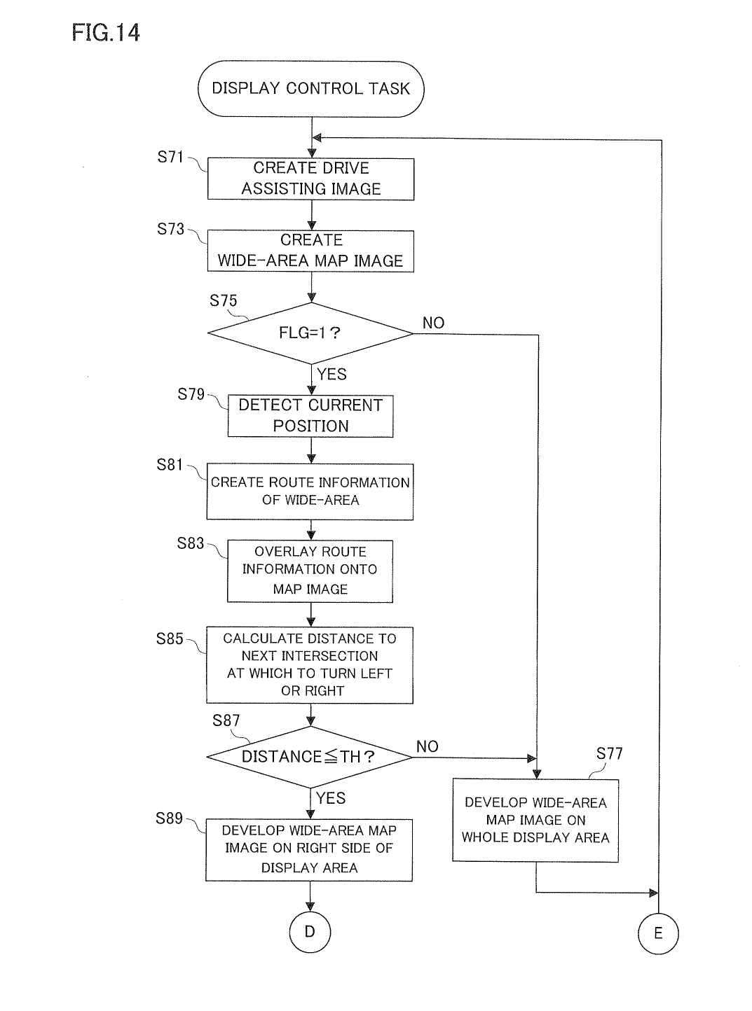

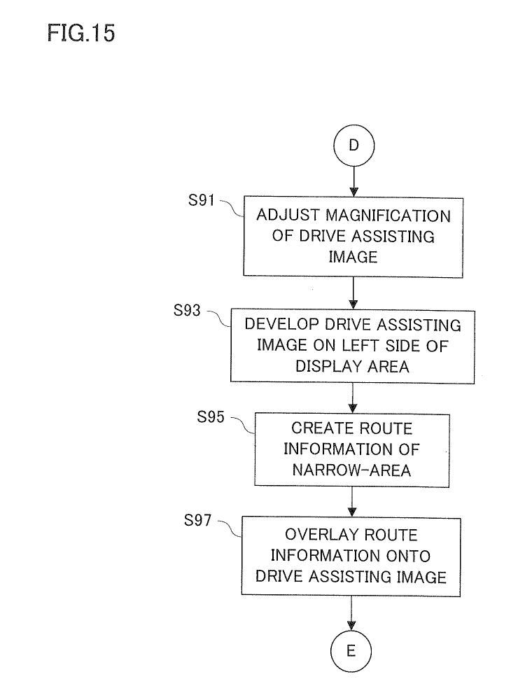

In this case, instead of the process according to the flowcharts shown in FIG. 9 to FIG. 12, a process according to flowcharts shown in FIG. 14 to FIG. 15 is executed.

With reference to FIG. 14, in a step S71, the drive assisting image ARV is created based on the object scene images P_0 to P_3 outputted from the cameras CM_0 to CM_3. In a step S73, the wide-area map image MP1 representing the current position of the vehicle 100 and its surrounding area are created based on the map data saved in the database 22. In a step S75, it is determined whether or not the flag FLG indicates “1”. When a determined result is NO, the process advances to a step S77 so as to develop the wide-area map image MP1 created in the step S73 on whole of the display area 14m. Upon completion of the process in the step S77, the process returns to the step S71.

When the determined result in the step S75 is YES, the process advances to a step S79 so as to detect the current position of the vehicle 100 based on the output of the GPS device 20. In a step S81, the route information RT1 indicating the route to the target site in a wide area is created. In a step S83, the created route information RT1 is overlaid onto the wide-area map image MP1 developed in the step S77. In a step S85, a distance to a next intersection at which to turn left or right is calculated based on the current position of the vehicle 100, the wide-area map image MP1, and the route information RT1. In a step S87, it is determined whether or not the calculated distance is equal to or less than a threshold value TH (=for example, 5 m), and when a determined result is NO, the process returns to the step S71 after the process in the step S77 and on the other hand, when the determined result is YES, the process advances to a step S89.

In the step S89, the wide-area map image MP1 created in the step S73 is developed on the right side of the display area 14m. In a step S91, the magnification of the drive assisting image ARV created in the step S71 is adjusted. In a step S93, the drive assisting image ARV having the adjusted magnification is developed on the left side of the display area 14m. In a step S95, the route information RT2 indicating the route to the target site in a narrow area is created. In a step S97, the created route information RT2 is overlaid onto the drive assisting image ARV developed in the step S93. Upon completion of the overlay process, the process returns to the step S71.

Thus, the drive assisting image ARV is displayed in parallel on the monitor screen at a timing at which the distance from the vehicle 100 to the intersection at which to turn left or right falls below the threshold value TH (that is, at a timing at which the vehicle 100 is about to enter the intersection). The driver is capable of visually confirming the surrounding area of the vehicle 100 through the monitor screen under a circumstance where confirming the safety of the surrounding area of the vehicle 100 is important, for example, at a time of turning right or left at the intersection. Thus, the drive assisting performance is improved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
a plurality of cameras which are arranged at respectively different positions of a moving body moving on a reference surface and which output object scene image representing a surrounding area of the moving body;
a first creator which creates a bird's-eye view image relative to the reference surface, based on the object scene images outputted from said plurality of cameras;
a first displayer which displays the bird's-eye view image created by said first creator, on a monitor screen;
a detector which detects a location of the moving body, in parallel with a creating process of said first creator;
a second creator which creates navigation information based on a detection result of said detector and map information; and
a second displayer which displays on the monitor screen the navigation information created by said second creator, in association with a displaying process of said first displayer.

2. An image processing apparatus according to claim 1, wherein the navigation information includes a map image, and said first displayer includes a first overlayer which overlays the bird's-eye view image onto the map image.

3. An image processing apparatus according to claim 2, wherein the moving body and the reference surface are equivalent to a vehicle and a road surface, respectively, and said first displayer further includes a determiner which determines an overlay position of the bird's-eye view age by referring to a road surface paint.

4. An image processing apparatus according to claim 3, wherein said determiner determines the overlay position by further referring to an orientation of the moving body.

5. An image processing apparatus according to claim 1, wherein the navigation information includes route information visibly indicating a route to the target site, and said second displayer includes a second overlayer which overlays the route information onto the map image and/or the bird's-eye view image.

6. An image processing apparatus according to claim 1, further comprising an issuer which issues a warning when an obstacle is detected from the surrounding area of the moving body.

7. An image processing apparatus according to claim 1, wherein the moving body and the reference surface are equivalent to a vehicle and a road surface, respectively, said image processing apparatus further comprising:
a calculator which calculates a distance from the moving body to an intersection at which to turn left or right based on the detection result of said detector and the map information; and
a controller which permits/restricts a displaying process of said first displayer depending on the distance calculated by said calculator.
